(19) United States
(12) Patent Application Publication
(10) Pub. No.: US 2008/0006209 A1
(43) Pub. Date: Jan. 10, 2008

(54) Retractable Arm Assembly For Milking Cows

(75) Inventors: John Murray Bowers, Ahuriri (NZ); Russell N. Kolstad, Waunakee, WI (US); David J. Luzader, Cleveland, TN (US); Braedyn Smith, Murchison (NZ); Michael W. Ellis, Kansas City, MO (US)

Correspondence Address: LATHROP & GAGE LC, 2345 GRAND AVENUE, SUITE 2800, KANSAS CITY, MO, 64108, US

(73) Assignee: DELAVAL HOLDINGS AB, Tumba (NZ)

(21) Appl. No.: 11/758,446

(22) Filed: Jun. 5, 2007

Related U.S. Application Data
(60) Provisional application No. 60/811,179, filed on Jun. 6, 2006.

(51) Int. Cl. A01J 5/00

(52) U.S. Cl. 119/14.11

(57) ABSTRACT

A retractable arm assembly for use in positioning a milker arm near the teats of a cow is disclosed. The retractable arm assembly allows a milker claw to be stored above a milking platform in a clean, safe position, and then automatically extended to the milking position and maintained in that position until the milker claw has been removed from the teats of the cow. The retractable arm assembly includes a movable milker arm having an interior chamber for receiving a chain to which the milker claw attaches. A lever arm connected to the milker arm faciliates movement of the milker arm in a downward and outward path around and behind the cow's rear leg. Both the chain and the milker arm can be selectively extended and retracted.

### RELATED APPLICATIONS This application claims the benefit of priority to commonly-owned and copending U.S. Provisional Patent Application No. 60/811,179, which is incorporated herein by reference.

### FIELD OF INVENTION

The field of this invention is equipment for milking cows, and, more specifically, a retractable arm for use with automated milking equipment on a rotary platform. The retractable arm is stored inside an automation cabinet; it extends out of the cabinet to position the milker claw behind the cow for attachment by an operator.

### BACKGROUND OF INVENTION

Retractable arms have been used on rotary platforms for several years. Currently, DeLaval offers a folding, two-piece arm that moves in the horizontal plane, extending out from under the cabinet overhang to a position behind the cow. See generally U.S. Pat. Nos. 6,289,845, 6,752,101, and 6,843,203. A disadvantage of this arm is that it must be manually moved by the operator from the retracted/storage position to the milking position. Another disadvantage is that the arm tends to fold up and retract before the chain is retracted enough to pull the milker claw from the cow, which results in the chain dragging around the cow's leg.

Westfalia-Surge has an arm that rotates from the milking position to a storage position, but this arm drops the milker claw below the milking platform. See U.S. Pat. Nos. 6,814,027 and 6,990,923. Applicant's invention allows the milker claw to be stored above the milking platform in a cleaner, safer position, while automatically extending the arm to the milking position and maintaining the arm in that position until the chain has been retracted sufficiently to remove the milker claw from the teats of the cow.

### BRIEF DESCRIPTION OF THE INVENTION

The invention has an arm assembly comprising a short pivotable upper arm that drives a longer lower milker cluster support or milker arm via a pivot point at the connection between the two pieces. The movement of the arm assembly is generally in a downward and outward direction from a milking cabinet in which it is housed. The movement of the milker arm is angled to improve the direction of movement of the lower milker arm toward the cow. The milker arm is also curved somewhat to allow it to stay behind the cow's rear leg. A chain is routed through a chamber in the lower milker arm. A distal end of the chain is attached to a milker claw that is attached to the cow's teats for milking.

An air cylinder is attached to the upper arm to pivot it for retraction and extension. A second air cylinder retracts and extends the chain to the milker claw. When signaled by an input, the chain cylinder extends immediately, which extends the chain. After a short delay, the arm cylinder extends as well, thereby extending the arm and permitting attachment of the milker claw to the cow's teats.

To retract the milker claw, the chain cylinder starts retracting the chain to draw the milker claw from under the cow to the end of the arm. After a slight delay to allow for that movement, the arm cylinder then retracts the arm into the cabinet, leaving the milker claw hanging in front of the cabinet beneath an overhang that shields it from access by both the exiting cow and the next cow entering the stall.

### DESCRIPTION OF THE DRAWINGS

FIG. 1 is a front view of a retractable arm assembly of the invention with the arm retracted.

FIG. 2 is a rear view of the retractable arm assembly with the arm retracted.

FIG. 3 is a front view of the retractable arm assembly with the arm extended.

FIG. 4 is a rear view of the retractable arm assembly with the arm extended.

FIG. 5 is side view of a cabinet of the invention showing a cutaway of the retractable arm assembly with the arm retracted.

FIG. 6 is side view of the cabinet showing a cutaway of the retractable arm assembly with the arm extended and further showing an extended chain with attachment for a milker claw.

FIG. 7 is a diagram of an alternative embodiment of the air supply logic of the retractable arm assembly of the invention.

FIG. 8 is a side view of the cabinet showing the retractable arm in the retracted position with the milker claw attached.

FIG. 9 is a diagram of the air supply logic of the retractable arm assembly of the invention.

### DETAILED DESCRIPTION OF THE INVENTION

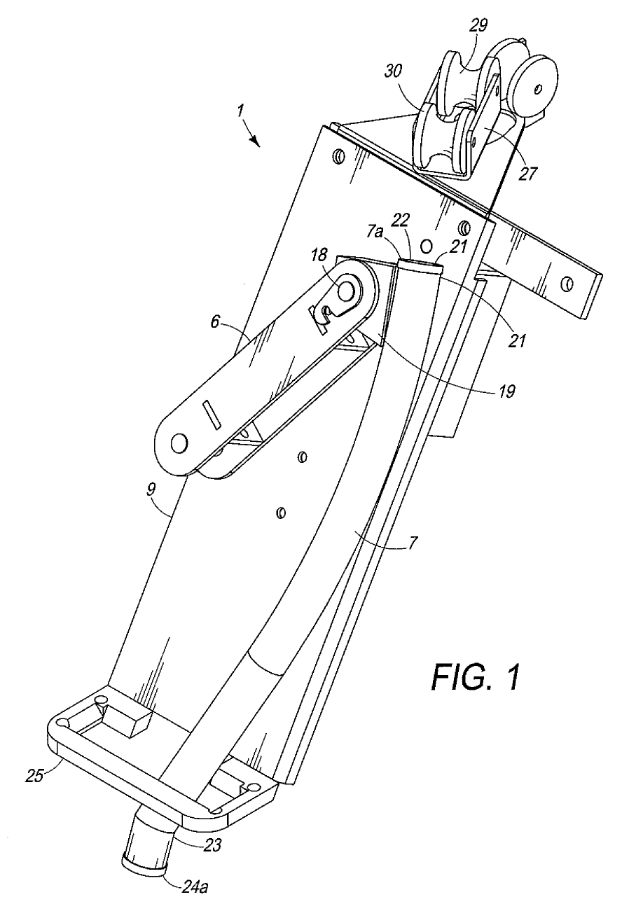

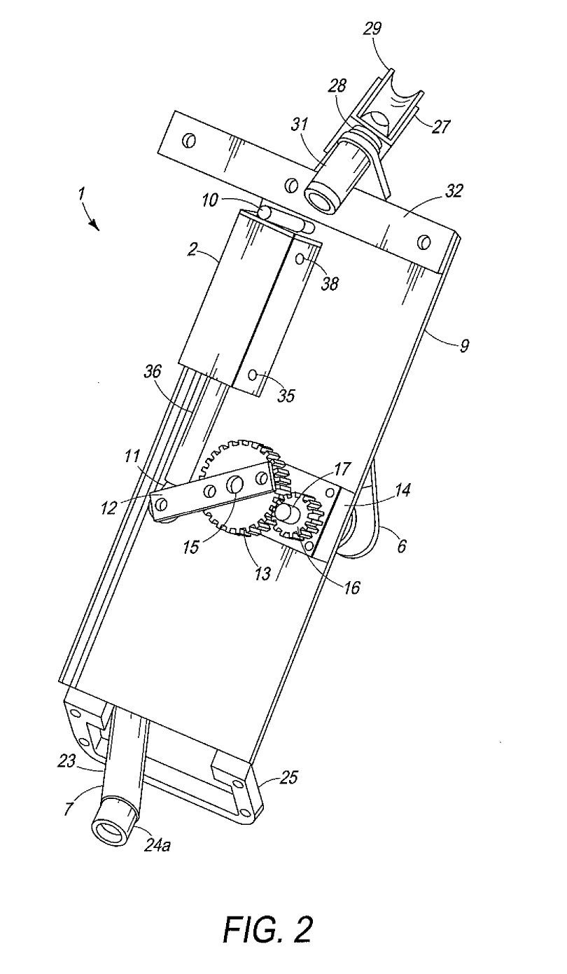

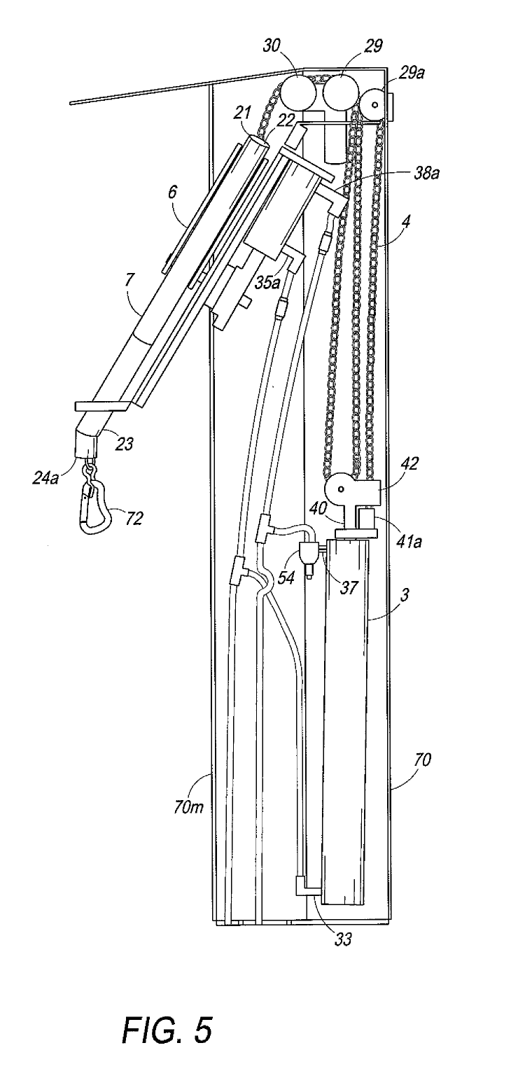

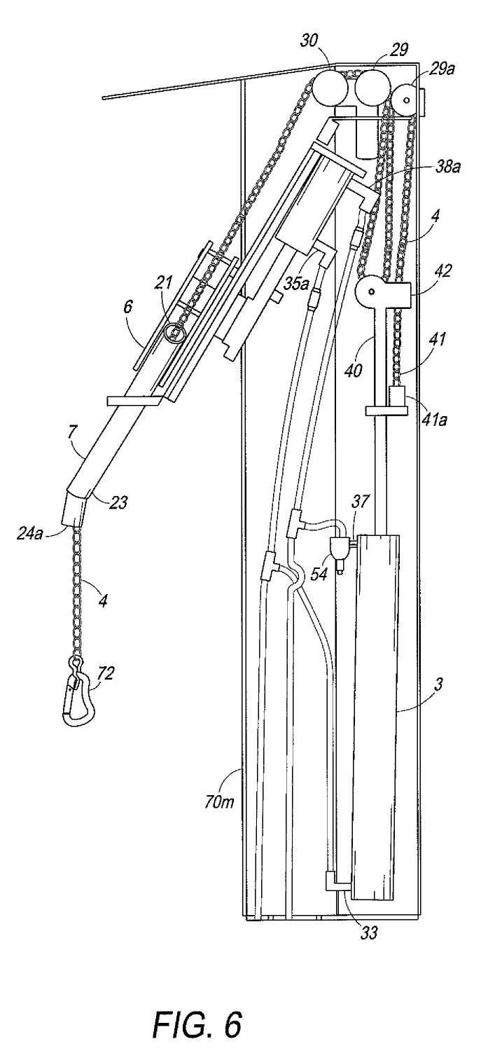

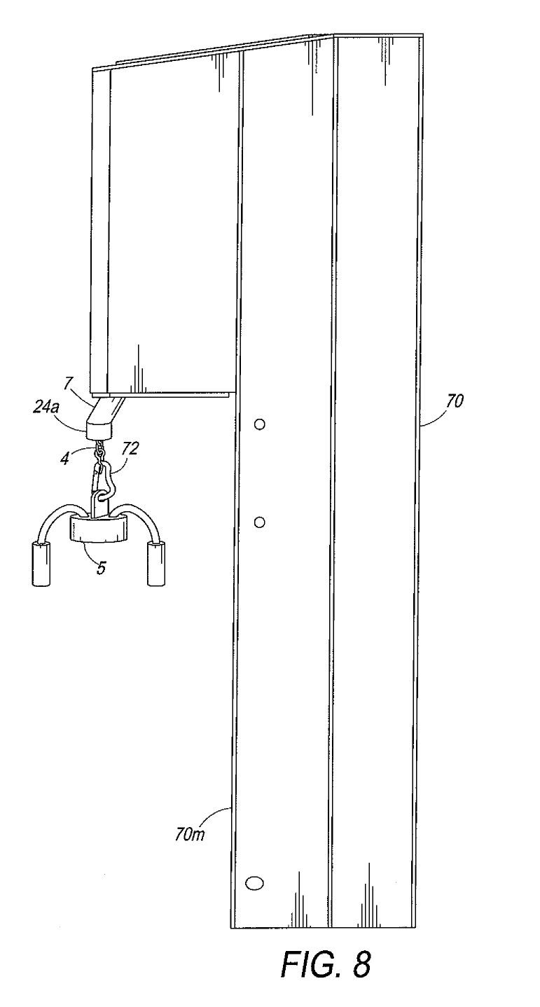

As shown in FIGS. 1 and 2, a retractable arm assembly 1 comprises a short upper arm 6 that drives a longer lower milker arm 7 with a pivot point 18 at the connection between the upper lever arm 6 and a proximal end 21 of the lower arm 7. As shown in FIG. 2, an arm air cylinder 2 operates the upper arm 6. As shown in FIG. 6, a chain air cylinder 3 extends and retracts a chain 4, a distal end of which is attached to a milker cluster or claw 5 (See FIG. 8). As shown in FIGS. 5 and 8, each stall on a rotary milking platform assembly has a cabinet 70 that houses a milking control (not shown), as well as the retractable arm assembly 1.

As shown in FIGS. 1, 4, and 6, the movement of the arm assembly 1 is in a plane that is angled from the vertical to improve the direction of movement of the lower arm 7 toward a cow. The lower milker arm 7 is slightly curved to allow it to stay behind the cow's rear leg during movement. The chain 4 is routed through the milker arm 7, and attached to the milker claw 5, as shown in FIGS. 5 and 6.

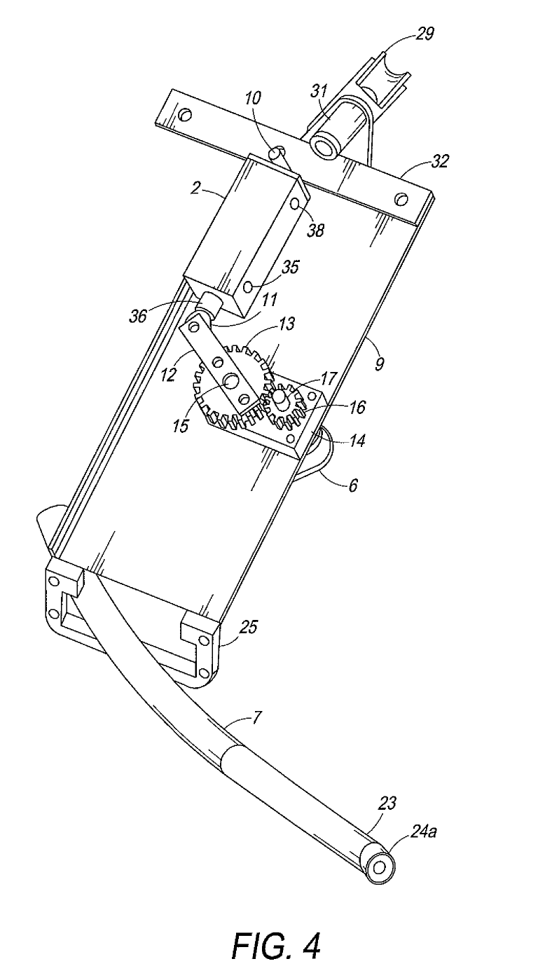

As further shown in FIG. 2, the air cylinder 2 is mounted to a plate 9 at a pivot 10 and attached to the upper arm 6 with a rotating joint 11 at a bar 12. (See also FIG. 4.) The bar 12 is attached to a gear 13 on a bearing block 14, with a shaft 15 through the gear 13 and the bearing block 14. As further shown in FIGS. 2 and 4, the gear 13 has teeth that mesh with teeth on a gear 16, which is also mounted on the bearing block 14. The gear 16 is on a shaft 17 that extends through the bearing block 14 and the mounting plate 9 and into the upper arm 6. The gear ratio between gear 13 and gear 16 allows for the proper movement of the arm 6 when the rod 36 of cylinder 2 is extended or retracted by air pressure.

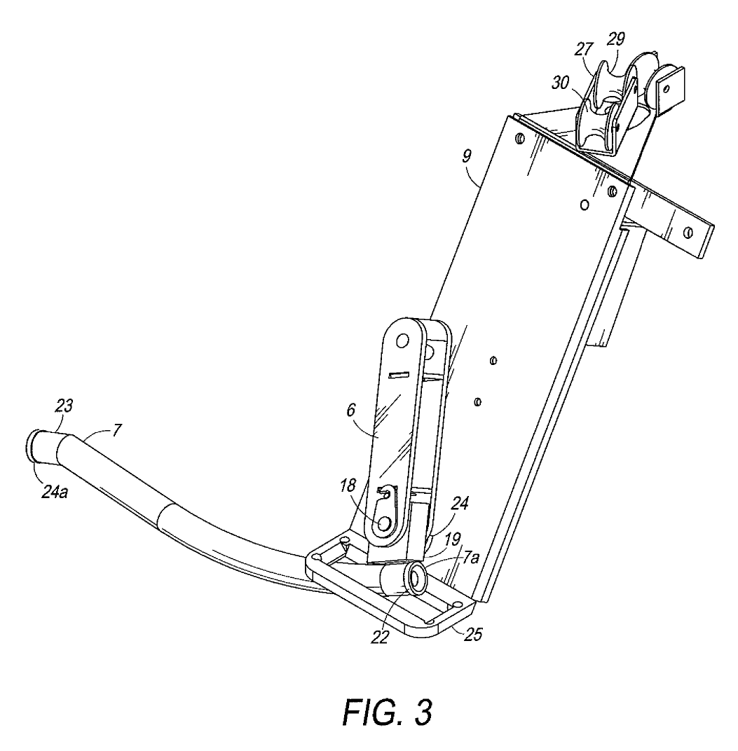

The upper arm 6 could be made from structural tubing or simply from plates or bars that are connected to provide a strong member to drive the movement of the lower arm 7. As shown in FIG. 3, the upper arm 6 has a bearing block 24 attached to the underside of the upper arm 6. The bearing block 24 slides along plate 9, thus, providing support with minimal friction.

As also shown in FIGS. 1 and 3, the lower milker arm 7 is connected to the upper arm 6 with a pin 18 through a block 19 attached to the lower arm link 7a. A wear bushing 22 is inserted into the upper proximal end 21 of the lower arm link 7a to guide the chain 4 into the upper end 21 of the lower arm 7. See FIG. 3. In an alternative embodiment, a pulley (not shown) is attached to the block 19 to guide the chain 4 into the upper end 21 of the lower arm 7.

The lower arm 7 is made from a structural tube that will provide adequate strength and is hollow to allow passage of the chain 4 through it. FIGS. 1-6 show a round lower arm tube 7, but a square tube could also be used. As shown in FIGS. 1-4, at a lower distal end 23 of the lower arm 7 a wear bushing 24a is inserted that guides the chain 4 and provides a replaceable wear surface. The bushing 24a also directs the chain 4 at the appropriate angle toward the cow. The lower arm 7 moves through a plastic guide plate 25 that is attached to the plate 9 providing the entry/exit point for the lower arm 7 from the cabinet 70 and providing support with minimal friction to lower arm 7 throughout its movement.

The air cylinder 3 (FIG. 6) has a cylinder rod 40 that retracts and extends the chain 4 connected to the milker claw 5. The cylinder 3 is mounted inside the cabinet 70 so the chain 4 is routed over pulleys 29 and 30 and into the upper end 21 of the lower arm 7.

An end 41 of the chain 4 is securely attached to a connector 41 a that is in slidable engagement with the cylinder rod 40, as shown in FIGS. 5 and 6. The chain 4 extends through an opening in a housing of pulley 42, up to and around a pulley 29a, down around pulley 42, back up over pulleys 29, 30, and then down through lower arm 7. Other suitable chain routings may be used in the event the stroke length of the cylinder rod 40 or the length of the cylinder 3 requires a different routing. Any routing and chain length that permits the chain 4 and milker claw 5 to reach under the cow for connection to the teats for milking will work satisfactorily.

As shown in FIGS. 1 and 2, the pulleys 29 and 30 are mounted to a bracket 27 with a pivot pin 28. The pivot pin 28 inserts into a pivot sleeve 31, which is welded to a mounting bar 32. The mounting bar 32 attaches to the cabinet 70 to provide support for the mounting plate 9.

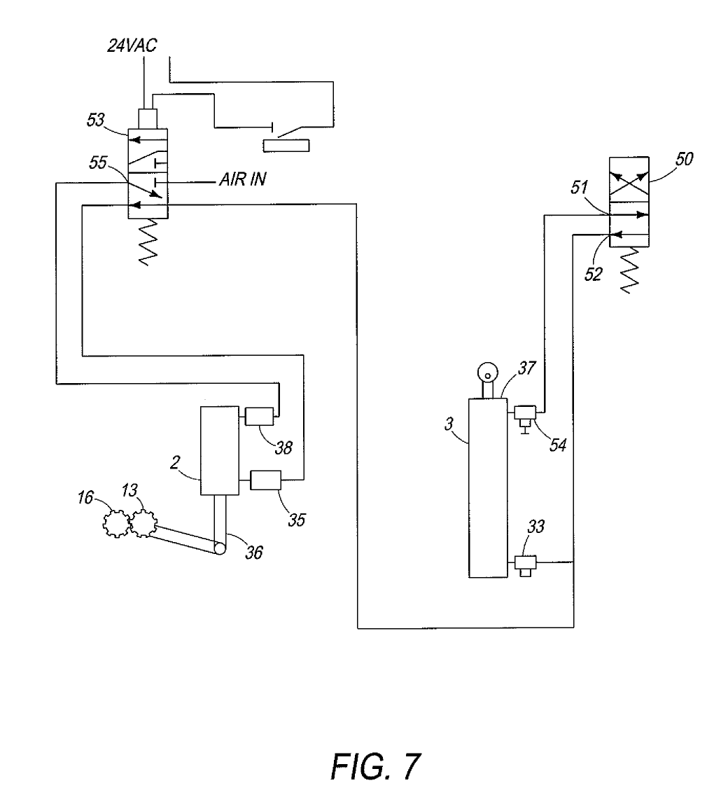

As shown in FIG. 7, to attach the milker claw 5 to the teats of the cow, an operator presses a start button (not shown), thereby signaling an air valve 50 which supplies compressed air to the cylinders 2 and 3. As shown in FIGS. 6 and 7, air is applied to the extend port 33 of the chain cylinder 3 so as to extend the chain 4. After a brief delay, air is applied to the retract port 35 of the arm cylinder 2 thereby extending the upper arm 6. (See FIGS. 2 and 7.) As the rod 40 of chain cylinder 3 extends, the weight of claw 5 pulls the chain 4 through lower arm 7. At the same time, arm cylinder 2 is retracting due to air pressure being applied to the cylinder retract port 35. As the cylinder rod 36 retracts into cylinder 2, the bar 12 rotates the gear 13, which in turn rotates the gear 16. The gear 16 rotates the shaft 17, which then moves the upper lever arm 6. As upper arm 6 is moved downward it drives lower milker arm 7, pivoting at the pin 18, such that milker arm 7 moves on a path downward and outward to a position behind the rear leg of the cow, where the milker claw 5 may be attached to the cow's teats. Thus, the movement of the milker arm 7 describes a path around and behind the cow's rear leg to arrive at a position for optimal retraction of the milker claw 5 to the distal end of milker arm 7 in order to avoid contact of the chain 4 and the milker claw 5 with cow's rear leg. Moreover, the extension of the milker arm 7 may be delayed with regard to the extension of the chain 4 such that attachment of the milker claw 5 may begin prior to the arrival of the milker arm 7 at its extended position.

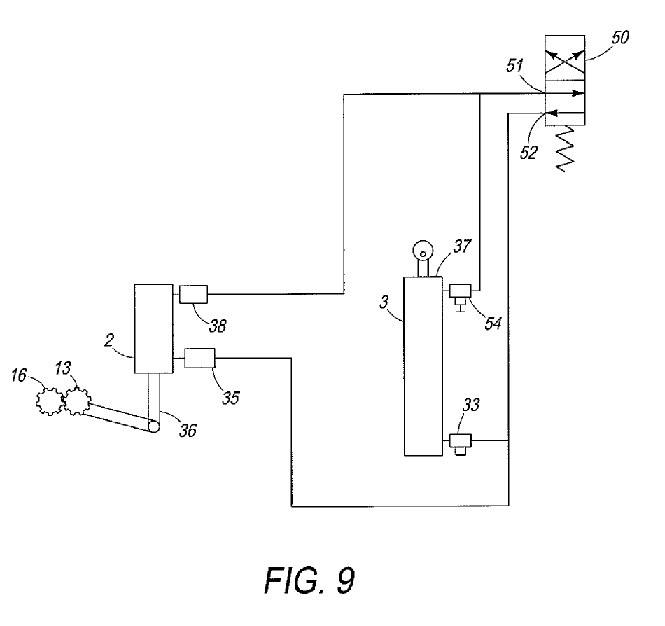

To retract the milker claw 5, the air valve 50 (see FIG. 9) is signaled and air is applied to the retract port 37 of the chain cylinder 3 to retract the chain 4, while air is exhausted from port 33. At the same time, air is applied to the arm cylinder extend port 38, delayed by a flow control, and retract port 35 is exhausted so the cylinder rod 36 of cylinder 2 moves the upper arm 6 to the retracted position. As the chain 4 is retracted into the cabinet 70, it pulls the milker claw 5 from under the cow to the end bushing 24a of the lower milker arm 7. As the milker claw 5 is pulled up against the end of the lower arm 7, the delayed action of the arm cylinder 2 retracts the milker arm 7 on a path upward and inward into the cabinet 70, leaving the milker claw 5 hanging in front of the cabinet 70 (see FIG. 8) and above the milking platform, shielded from access by the cow when exiting a stall and also shielded from the next cow entering the stall. In this position the milker claw 5 is also in a position where it may be kept sanitary. After the chain cylinder 3 is air powered during retraction, a second air valve (not shown) may, if desired, be used to apply air to the extend port 38 of the arm cylinder 2, after an adjustable delay. (See FIG. 7.)

Retract Arm Air Logic:

As shown in FIG. 9, the two cylinders 2 and 3 are controlled by a 4-way electric solenoid air valve 50 that is controlled by the stall milking controller (not shown). In the standby position, the lower arm 7 is retracted into the cabinet 70 and the milking claw 5 is hanging beneath the front of the cabinet 70, as shown in FIG. 8. To attach the milker claw 5 to the cow, the operator presses the start button (not shown) on the cabinet 70, which signals the milking controller to de-energize the solenoid of the air valve 50 and, thus, shifts the air supply from port 51 to port 52. Compressed air is supplied to the extend port 33 of the cylinder 3 and simultaneously to the retract port 35a of the arm cylinder 2. In an alternative embodiment shown in FIG. 7, the air supplied to cylinder 2 goes through a second 4-way electric solenoid air valve 53 which is in an open position when in the normal standby position.

As compressed air enters the port 33, a flow control valve 54 on the port 37 restricts the air flow out of the cylinder 3 to control the speed of the cylinder rod 40 as it extends. See FIG. 9. Simultaneously, as air enters the port 35a of the cylinder 2, the flow control valve 38 on the port 38a restricts the air flow out of the cylinder 2 to control the speed of the cylinder rod 36 as it retracts.

The arm assembly 1 is retracted when milk flow from the cow drops to a predetermined level as measured by a flow sensor or milk meter. The signal from the sensor or meter to the stall controller generates a signal from the controller to the valve 50, energizing the solenoid and shifting the valve 50 so air is supplied to the port 51. See FIG. 9. Air is released from the port 33 of the cylinder 3 as air enters the port 37. Simultaneously, air is released from port 35a of cylinder 2, so the cylinder 2 is no longer held in the retracted position. As the chain cylinder 3 retracts, it pulls the chain 4 into the end 23 of the arm 7 until the milker claw 5 is against the end bushing 24a. Air is released from port 35a, slowed by the flow control 35 of cylinder 2 as air enters port 38a. The extension of rod 36 pulls the lower arm 7 (and thus the upper arm 6) into the cabinet 70.

When the milking session is ended, to facilitate cleaning the milking claw 5, it is useful to release the chain 4 without extending the lower arm 7 from the cabinet 70. In the alternative embodiment of FIG. 7, this may be accomplished by means of the second 4-way valve 53. The valve 53 has a separate air supply and a separate power supply, and, in an alternative embodiment, is controlled by a switch on the cleaning unit door on the front of the cabinet 70. When the cleaning unit door 70m is opened, a switch closes so as to allow power to the valve 53, which then applies air to the port 55, and, subsequently, to the port 38a of the cylinder 2. The air so-supplied holds the cylinder 2 in the extended position, thereby keeping the upper arm 6 in the retracted position. In this mode, when the start button (or a specified cleaning mode button) is pressed, the valve 50 is de-energized, thereby applying air to the port 33 and extending the cylinder 3 to release the chain 4, but the valve 53 prevents air from going to the port 35a of the cylinder 2 and extending the arm assembly 1.

When the cleaning process is completed, to prepare the system for milking, the chain 4 and the milker claw 5 are retracted by pressing a remove button. In an alternative embodiment, the cleaning unit door 70m is closed, thereby opening the switch and de-energizing the valve 53. The air to the port 38a of the upper cylinder 2 is exhausted, and the arm assembly I is once again held in the retracted position by the arm cylinder 2.

For convenience, the milker claw 5 may be attached to the chain 4 by a spring hook 72, as shown in FIGS. 5, 6, and 8.

Although the milker arm 7, the chain 4, and the lever arm 6 are described above as being moved, respectively, by the compressed air cylinder 3 and the rod assembly 40 and the air cylinder 2 and the rod assembly 36, it is understood that the arm 7, the chain 4 and the lever arm 6, or any one or more of them could be moved by hydraulic cylinder and rod arrangements or electrical connections and components. It is also feasible to move the arm 7, the chain 4, and the lever arm 6, or any of them, manually. Moreover, the lower arm 7 and the chain 4 could be moved manually toward the teats of the cow to be milked and locked in place for milking against the bias of springs; in this event the arm 7 and the chain 4, when unlocked, would return to their storage positions due to the bias of the springs, with or without the use of the upper lever arm 6. In addition, while the lever 6 and its linkages are described above as the actuators for moving the lower milker arm 7 and other components of the retractable arm assembly 1, other types of actuators may be used. For example, a bell and crank actuator with appropriate linkages could be used in place of the upper lever arm. Pneumatic rotary actuators could also be used, as could actuators that comprise combinations of electrically operated or energized solenoids, pivots, and/or arms controlled by microprocessors or other types of control devices. Such actuators could be separately activated by a user or suitably programmed by the user or others to permit, as here, the retraction of the chain 4 before, after, or simultaneously with the movement of the milker arm 7 to its fully extended position or to its storage position, thus providing maximum flexibility, functionality, and efficiency in the use and operation of the milker arm 7 and the milker claw 5. Such actuators could also be used, as above, to move the milker arm 7 around and behind the cow's rear leg to place it in the proper position for attaching or begin the attachment of the milker claw 5 while, at the same time keeping the chain 4 and milker arm 7 away from the cow and the milking platform.

The changes described above, and others, may be made in the systems and methods described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

We claim:

1. A retractable arm assembly for use in positioning a milker arm near the teats of a cow for milking, the retractable arm assembly comprising:
a movable milker arm having distal and proximal ends and an interior chamber;
a lever arm pivotably connected to the proximal end of the milker arm whereby movement of the lever arm in a first direction forces the distal end of the milker arm downward and outward toward the teats of the cow; and
a chain passing through the milker arm interior chamber, a distal end of the chain being secured to a milker claw, the chain being selectively extendable and retractable to move the milker claw toward and away from the cow teats.

2. The retractable arm assembly of claim 1, wherein movement of the lever arm in a second direction forces the distal end of the milker arm upward and inward away from the teats of the cow.

3. The retractable arm assembly of claim 2) further comprising:
means for selectively extending and selectively retracting the chain; and
means for selectively moving the lever arm in the first and second directions.

4. The retractable arm assembly of claim 2, further comprising:
at least one supply of compressed air;
an air cylinder operatively coupled to the compressed air supply and the lever arm to selectively move the lever arm in the first and second directions; and
another air cylinder operatively coupled to the compressed air supply and the chain to selectively extend and retract the chain.

5. The retractable arm assembly of claim 2, further comprising a controller operatively coupled to the lever arm and the chain to selectively cause the lever arm to move in the first and second directions and to selectively cause the chain to extend and retract, wherein the controller causes the chain to begin extending before causing the lever arm to move in the first direction.

6. The retractable arm assembly of claim 1, wherein the retractable arm assembly is housed in a cabinet.

7. The retractable arm assembly of claim 1, wherein the milker arm is movable between a storage configuration above a milking platform and a use configuration adjacent the cow teats.

8. The retractable arm assembly of claim 1, wherein the milker arm is curved.

9. The retractable arm assembly of claim 1, wherein the distal end of the milker arm includes a bushing to guide the chain into the milker arm interior chamber.

10. An automated cow milking assembly, comprising:
a cabinet secured to and extending upward from a milking platform;
a hollow milker tube movable between a retracted configuration inside the cabinet and above the milking platform and a use configuration outside the cabinet;
a lever arm pivotably connected to the milker tube to move the milker tube between the retracted and use configurations; and
a chain passing through the milker tube, the chain being extendable and retractable and having a distal end coupled to a milker claw; and
wherein the milker claw is above the milking platfonn when the milker tube is at the retracted configuration and the chain is retracted.

11. The milking assembly of claim 10, wherein the milker claw is attachable to the teats of a cow for milking when the milker tube is at the use configuration and the chain is extended.

12. The milking assembly of claim 10, wherein a movable rod connected to the lever arm moves the lever arm.

13. The milking assembly of claim 10, wherein a movable rod connected to the chain extends and retracts the chain.

14. The milking assembly of claim 10, wherein the lever arm is moved by compressed air and the chain is extended and retracted by compressed air.

15. The milking assembly of claim 10, wherein:
the milker tube moves downward and away from the cabinet in moving from the retracted configuration to the use configuration; and
the milker claw is adjacent the teats of a cow when the milker tube is at the use configuration and the chain is extended.

16. A retractable arm assembly for use in storing a cow milker claw above a milker platform, the retractable arm assembly comprising:
a retractable milker arm having a distal end and an interior chamber, the milker arm being retractable to an arm storage location above the milker platform;
a retractable milker chain having a medial portion disposed within the interior chamber of the milker arm, a distal end of the chain being secured to the milker claw; and
wherein the milker claw is at a storage location above the milking platform when the milker arm is at the arm storage location and the chain positions the milker claw adjacent the milker arm distal end.

17. The retractable arm assembly of claim 16, wherein a proximal end of the milker arm is coupled to a movable lever.

18. The retractable arm assembly of claim 17, wherein a proximal end of the milker chain is coupled to a movable member.

19. The retractable arm assembly of claim 18, wherein at least one of the movable lever and the movable member are moved manually.

20. The retractable arm assembly of claim 18, wherein at least one of the movable lever and the movable member are moved by compressed air.

21. The retractable arm assembly of claim 16, wherein the milker arm is curved.

22. The retractable arm assembly of claim 16, wherein:
a cabinet is mounted on the milker platform; and
the milker arm is inside the cabinet when at the arm storage location.

23. A method of selectively providing a milker claw adjacent the teats of a cow for milking, the method comprising the steps:
(a) moving a milker arm downwardly and outwardly relative to an initial position inside a cabinet;
(b) extending a chain that passes through the milker arm, the milker claw being attached to a distal end of the chain;
(c) retracting the chain to move the milker claw adjacent a distal end of the milker arm; and
(d) moving the milker arm upwardly and inwardly to the initial position inside the cabinet.

24. The method of claim 23, wherein step (b) is initiated before step (a) is initiated.

25. The method of claim 23, wherein the milker claw is above a milking platform when the milker arm is at the initial position and the milker claw is adjacent the milker arm distal end.

26. The method of claim 23, wherein the movement of the milker arm and the movement of the chain are automated.

27. The method of claim 23, wherein the milker arm moves around and behind the cow's rear leg.

28. The method of claim 23, wherein the downward and outward movement of the milker arm is delayed with regard to the extension of the chain.

29. A retractable arm assembly for use on automated cow-milking equipment, the assembly comprising:
a milker arm having proximal and distal ends;
a chain coupled to the milker arm, a distal end of the chain being secured to a milker claw, the chain being selectively extendable and retractable; and
a lever arm movable in opposite directions and being pivotally coupled to the proximal end of the milker arm to move the milker arm toward and away from a cow in the horizontal direction.

30. The assembly of claim 29, wherein the milker arm is curved to facilitate its horizontal movement.

31. The assembly of claim 29, wherein the lever arm is moved by compressed air.

32. The assembly of claim 29, wherein the milker arm further moves downwardly when moving toward the cow and upwardly when moving away from the cow.

33. The assembly of claim 29, wherein the milker claw is above a milking platform when the milker arm is moved away from the cow and the milker claw is adjacent the milker arm distal end.

34. A retractable arm assembly for use in positioning a milker arm near the teats of a cow for milking, the retractable arm assembly comprising:
a movable milker arm having distal and proximal ends and an interior chamber;
a actuator connected to the proximal end of the milker arm whereby movement of the actuator in a first direction forces the distal end of the milker arm downward and outward toward the teats of the cow; and
a chain passing through the milker arm interior chamber, a distal end of the chain being secured to a milker claw, the chain being selectively extendable and retractable to move the milker claw toward and away from the cow teats.

35. The retractable arm assembly of claim 34, wherein the milker arm moves around and behind the cow's rear leg.

36. The retractable arm of claim 34, wherein the downward and outward movement of the milker arm is delayed with regard to the extension of the chain.

37. The retractable arm assembly of claim 34, wherein movement of the actuator in a second direction forces the distal end of the milker arm upward and inward away from the teats of the cow.

38. The retractable arm assembly of claim 34, further comprising a controller operatively coupled to the actuator and the chain to selectively cause the actuator to move in the first and second directions and to selectively cause the chain to extend and retract, wherein the controller causes the chain to begin extending before causing the lever arm to move in the first direction
